(19) United States
(12) Patent Application Publication
(10) Pub. No.: US 2026/0013499 A1
(43) Pub. Date: Jan. 15, 2026

(54) DECARBOXYLATED ROSIN ACID AS A DRIFT CONTROL AGENT

(71) Applicant: Kraton Corporation, The Woodlands, TX (US)

(72) Inventors: Gerald Heebner, Savannah, GA (US); Rebekah Brucato, Savannah, GA (US)

(73) Assignee: Kraton Corporation, The Woodlands, TX (US)

(21) Appl. No.: 19/333,904

(22) Filed: Sep. 19, 2025

Related U.S. Application Data
(63) Continuation-in-part of application No. 18/762,825, filed on Jul. 3, 2024.
(60) Provisional application No. 63/511,715, filed on Jul. 3, 2023.
(60) Provisional application No. 63/696,625, filed on Sep. 19, 2024.

(51) Int. Cl. A01N 25/24; A01N 25/04; A01N 25/30; A01N 57/20; A01P 13/00

(52) U.S. Cl. CPC A01N 25/24; A01N 25/04; A01N 25/30; A01N 57/20; A01P 13/00

(57) ABSTRACT

The disclosure relates to agricultural spray compositions that reduce spray drift using a drift control adjuvant comprising decarboxylated rosin acid (DCR), a surfactant system, and optional components, in combination with an agricultural chemical component in a carrier. The drift control agent may be supplied as neat DCR or as part of the adjuvant. Methods include preparing the spray by (i) combining the adjuvant with a concentrated agricultural chemical component to form a concentrate composition and diluting with a carrier, or (ii) diluting the agricultural chemical component with a carrier and subsequently adding the adjuvant. When discharged through spray nozzles, the compositions increase droplet size and narrow the droplet-size distribution, thereby reducing fine droplets and spray drift while maintaining coverage and compatibility across a range of agricultural actives.

### RELATED APPLICATIONS

This application claims benefit to U.S. Provisional Application No. 63/696,625, filed Sep. 19, 2024, and is a continuation-in-part of U.S. patent application Ser. No. 18/762,825, filed on Jul. 3, 2024, which claims benefit to U.S. Provisional Application No. 63/511,715, filed Jul. 3, 2023, all of which are incorporated herein by reference.

### FIELD

The disclosure relates to the use of decarboxylated rosin acid as a drift control agent.

### BACKGROUND OF THE INVENTION

In modern agricultural practice, spray application is a widely used method for delivering agrochemicals such as herbicides, pesticides, plant growth regulators, fertilizers, etc. A persistent challenge with spray application is the generation of fine spray droplets (typically <150 μm in diameter) that are prone to wind drift. Spray drift can lead to off-target deposition, reduced efficacy of the applied product, and unintended damage to adjacent crops or sensitive vegetation. To address this issue, drift control adjuvants are commonly added to spray mixtures to modify droplet size distribution and reduce the proportion of fine droplets.

Conventional drift control adjuvants typically contain an oil component and a surfactant package. The oil components may be petroleum-derived, vegetable-based, or a methylated derivative thereof, and are generally included to aid droplet formation, spreading, and deposition. Such systems can be effective, but they may exhibit limitations such as supply variability, inconsistent biodegradability, reduced compatibility with diverse agrochemicals, or lack of performance consistency under varying field conditions.

Accordingly, there remains a need for drift reduction technologies that employ renewable or sustainable raw materials while providing reliable performance in agricultural spray applications.

### SUMMARY

In one aspect, an agricultural spray composition is disclosed. The agricultural spray composition comprises, consists essentially of, or consists of 0.02 to 5.0% v/v a drift control adjuvant, and 95-99.98% v/v of an agricultural chemical component selected from the group of herbicides, insecticides, fungicides, rodenticides, bactericides, nematicides, algaecides, growth regulators, micronutrients, fertilizers and mixtures thereof. The drift control adjuvant comprises, consists essentially of, or consist of: 50-95 wt. % of a decarboxylated rosin acid as a drift control agent; 5-50 wt. % of a surfactant system comprising one or more surfactants selected from nonionic, anionic, cationic, amphoteric surfactants, and mixtures thereof; and up to 20 wt. % optional components. The decarboxylated rosin acid comprises one or more C═C groups, and 40-100 wt. % of tricyclic compounds having 18-20 carbon atoms. The spray droplets formed from the agricultural spray composition when discharged through one or more spray nozzles exhibit at least one of: a volume mean diameter (VMD) of 215-430 μm, a fines fraction of 2-25% by volume for droplets having a diameter less than 141 μm, and a relative span of 0.9-1.5.

In an aspect, a method of preparing an agricultural spray composition is disclosed. The method comprises combining a drift control adjuvant with a concentrated agricultural chemical component to form a concentrate composition and diluting the concentrate composition with a carrier to provide the agricultural spray composition. The dilution being sufficient to provide 95.0 to 99.98% v/v of the agricultural chemical component in the agricultural spray composition. In embodiments, the dilution being sufficient to provide 0.1-2.0% v/v of the agricultural chemical active ingredient in the agricultural spray composition. The drift control adjuvant comprising, consists essentially of, or consist of 50-95 wt. % of a decarboxylated rosin acid, 5-50 wt. % of a surfactant system, and up to 20 wt. % of optional components. The decarboxylated rosin acid comprises one or more C═C groups, and 40-100 wt. % of tricyclic compounds having 18-20 carbon atoms. The agricultural chemical component is selected from herbicides, insecticides, fungicides, rodenticides, bactericides, nematicides, algaecides, growth regulators, micronutrients, fertilizers, and mixtures thereof.

In an aspect, a method of preparing an agricultural spray composition is disclosed. The method comprises diluting a concentrated agricultural chemical component with a carrier to provide a diluted agricultural chemical component composition, and adding a drift control adjuvant to the diluted agricultural chemical composition to form an agricultural spray composition comprising 95.0 to 99.98% v/v of the agricultural chemical component. In embodiments, agricultural spray composition comprises 0.1-2.0% v/v of the agricultural chemical active component. The drift control adjuvant comprises, consists essentially of, or consists of 50-95 wt. % of a decarboxylated rosin acid, 5-50 wt. % of a surfactant system, and up to 20 wt. % of optional components. The decarboxylated rosin acid comprises one or more C═C groups, and 40-100 wt. % of tricyclic compounds having 18-20 carbon atoms.

### DESCRIPTION

The following terms will be used throughout the specification.

“Consisting essentially of” means that the composition primarily includes the recited components and may additionally contain one or more components that do not materially affect the novel characteristics or intended function of the invention. In embodiments, such additional components are present in amounts of <30 wt. %, <20 wt. %, or <10 wt. %, based on total weight of the composition.

“Consisting of” refers to a composition that includes only the specifically listed components and excludes other components that materially affect the technical solution or distinctive function of the invention. However, the presence of other components in small amounts that do not materially affect the technical effect of the invention is not excluded, such as trace-level stabilizers, process residues, or solvents used during preparation.

As used herein, transitional terms such as ‘comprising,’ ‘consisting essentially of,’ and ‘consisting of’ are intended to carry its conventional meaning as understood in patent law, or defined when appropriate.

“At least one of [a group such as A, B, and C]” or “any of [a group such as A, B, and C]” means a single member from the group, more than one member from the group, or a combination of members from the group. For example, at least one of A, B, and C includes, for example, A only, B only, or C only, as well as A and B, A and C, B and C; or A, B, and C, or any other combinations of A, B, and C. In another example, at least one of A and B means A only, B only, as well as A and B.

A list of embodiments presented as “A, B, or C” is to be interpreted as including the embodiments, A only, B only, C only, “A or B,” “A or C,” “B or C,” or “A, B, or C.”

“Any of A, B, or C” refers to one option from A, B, or C.

“Any of A, B, and C” refers to one or more options from A, B, and C.

“Decarboxylated rosin acid” or “DCR” refers to a compound/material obtained by decarboxylation of rosin acid by removal (or loss) of a carboxyl group (—COOH). The decarboxylation process is typically carried out through heating or other methods, which results in loss of the carboxyl group. This chemical transformation changes the properties of the compound, including its solubility and reactivity.

“Hydrogenation of DCR” refers to a reaction involving the addition of hydrogen (H₂) to DCR, resulting in the saturation of carbon-carbon double bonds to obtain a hydrogenated decarboxylated rosin acid (HDCR) composition. The hydrogenation of DCR aims to modify its chemical structure to enhance certain properties or achieve specific characteristics, e.g., stability, color, etc.

“Average Double Bond Equivalent” or “Average DBE” or “Ave. DBE” refers to the degree of unsaturation or the number of double/triple bonds present in a compound, and can be measured by GC-MS. The Ave. DBE is computed based on the DBE of the components in the compound:

$$Ave . DB E = sum of [ each component ( wt . \% ) ⋆ DBE of each component ] \qquad ( I )$$

“Hydrogenation percentage (%)” refers to the percentage of double bonds hydrogenated in a compound/molecule relative to the presence of double bonds in the compound/molecule prior to the hydrogenation. Hydrogenation of one double bond corresponds to 100% hydrogenation.

Hydrogenation % of rosin acid is based on the Ave. DBE of rosin acid before and after hydrogenation:

$$Hydrogenation \% = ( Ave . of rosin acid ) - ( Ave . DBE of hydrogenated rosin acid ) ⋆ 100 \qquad ( II )$$

Hydrogenation % of HDCR composition is based on the Ave. DBE of the DCR feedstock before and the HDCR composition after hydrogenation:

$$Hydrogenation \% = ( Ave . DBE of DCR ) - ( Ave . DBE of HDCR composition ) ⋆ 100 \qquad ( III )$$

“Carrier” refers to a liquid suitable for agricultural spraying that dissolves, disperses, or suspends the agricultural chemical component and/or the drift control adjuvant, and is agriculturally acceptable (e.g., compatible with intended crops, equipment, and field conditions). Carriers include water and solvent carriers (alone or in any proportion), such as aliphatic or aromatic hydrocarbons, alcohols, glycols and glycol ethers, esters (e.g., methylated seed oil, crop oil concentrates), vegetable oils and derivatives, and mixtures thereof. A carrier can further include routine inerts such as antifoams, pH adjusters, corrosion inhibitors, and humectants.

“Concentrate” or “Concentrated agricultural chemical component” means a composition in which the agricultural chemical component is present at a concentration greater than its concentration in the agricultural spray composition and which is intended to be diluted with a carrier prior to application. The concentrated agricultural chemical component may be (i) an agricultural chemical active ingredient in neat, technical, salt, or ester form, or (ii) an agricultural chemical formulation (e.g., soluble/liquid concentrate (SL), emulsifiable concentrate (EC), suspension concentrate/flowable (SC), microemulsion (ME), oil dispersion (OD)), optionally containing one or more solvents, carriers, surfactants, or inerts. The extent of concentration (dilution factor) is not limited, and may vary by product and label; examples include factors greater than 1× (e.g., 2-500 × or more) before dilution to field-use levels.

“Concentrate composition” means a mixture obtained by combining the drift control adjuvant with the concentrated agricultural chemical component prior to dilution with a carrier. The concentrate composition may include additional agriculturally acceptable inerts.

“Drift control agent” comprises, consists essentially of, or consists of

decarboxylated rosin acid (“DCR”). The drift control agent can be incorporated directly into an agricultural composition to reduce spray drift.

“Drift control adjuvant” refers to an additive composition comprising a decarboxylated rosin acid and a surfactant system, optionally with additional components, and is included in an agricultural spray composition to modify spray droplet characteristics and reduce drift.

“Agricultural” compositions refer to pesticides, growth regulators, micronutrients, and fertilizers. Pesticides include herbicides, insecticides, fungicides, rodenticides, bactericides, nematicides, algaecides, or mixtures thereof.

“Agricultural chemical component” refers to either (i) an agricultural chemical active ingredient, or (ii) an agricultural chemical formulation containing such agricultural chemical active ingredient together with a carrier.

“Agricultural spray composition” refers to a composition suitable for spraying that comprises a drift control adjuvant and an agricultural chemical component. Agricultural spray compositions as disclosed herein are typically diluted formulations ready for application, and are characterized in embodiments by spray droplet size distributions, fines fractions, and relative span values as described herein.

“Mist” or “spray droplets” are droplets less than 150 μm in diameter. In embodiments, the term “percent fines” refers to the proportion of the total spray volume comprised of droplets below a specified cutoff diameter that are considered drift-prone. For example, percent fines or “fine fraction” may be defined as droplets smaller than 141 μm.

“Solubility Parameter” or (δ) of a solvent or polymer refers to the square root of the vaporization energy (ΔE) divided by its molar volume (V), as in the equation δ=(ΔE/V)½. The more similar the solubility parameters of two substances, the higher will be the solubility between them and hence the expression “like dissolves like.” Hansen established that the solubility parameter of a solvent or polymer is the result of the contribution of three types of interactions: dispersion forces (δD2), polar interactions (δP2), and hydrogen bonds (δH2) (Hansen, 2007; Hansen, 1967), with the total solubility (Hildebrand) parameter δT as the result of contribution of each of the three Hansen solubility parameters (HSP) according to: δT=(δ2D+δ2P+δ2H)½.

Unless otherwise indicated, percentages of the agricultural spray composition are expressed as % v/v relative to the total volume including the carrier. Percentages describing the internal formulation of the drift control adjuvant are wt. %. For purposes of the present disclosure, wt. % and v/v % are treated as equivalent where the density of the drift control adjuvant, the decarboxylated rosin acid, the agricultural chemical component, and the carrier are each within 0.8-1.1 g/mL; otherwise, conversion may be made using measured densities.

The disclosure relates to the use of decarboxylated rosin acid as a drift control agent and to drift control adjuvant compositions containing DCR, a surfactant, and optional components. The disclosure further relates to agricultural compositions containing such adjuvants, and methods of reducing spray drift during the spraying.

Decarboxylated Rosin Acid (DCR): DCR is a rosin-derived compound obtained

by decarboxylating a rosin acid, or by dimerizing and decarboxylating a rosin acid and separating/removing the dimerized species. DCR is in the form of a liquid, and can be any of a crude DCR, a distilled or purified DCR, or mixtures thereof. DCR can be hydrogenated and/or functionalized. Crude DCR is DCR containing 5-25 wt. % of higher molecular weight (450-1500 Da) components, e.g., hydrocarbons, oligomers, polymers, impurities, or dimer/trimer of fatty acids. Distilled or purified DCR refers to crude DCR having heavy fractions removed to improve color, reduce sulfur content, etc. Hydrogenated DCR (“hDCR”) refers to DCR that has undergone hydrogenation to reduce C═C double bonds yielding hydrogenated DCR compounds. Unless specified otherwise, DCR herein refers to both unhydrogenated DCR (crude, distilled or purified), or hydrogenated DCR.

DCR is produced by the decomposition of rosin acids at high temperatures, e.g., 220-300° C. Rosin acids are normally solid, having a softening point of, e.g., 65-85° C. The rosin acid can be fully decarboxylated forming DCR. The rosin acid can be partially decarboxylated, forming DCR, which is a mixture of molecules, some of which contain monocarboxylic acids having a general molecular formula, e.g., C20H30O2.

In embodiments, DCR comprises one or more C═C groups, 40-100 wt. % of tricyclic species having 18-20 carbon atoms, 0-30 wt. % of components with <19 carbon atoms, and 40-100 wt. % of components with a molecular formula in the range from C19H20 to C19H34, based on the total weight of the DCR. In embodiments, sum of tricyclic species as aromatic and cycloaliphatic in the DCR is >50 wt. %, or >55 wt. %, or >60 wt. %, or >74 wt. %, or >90 wt. %, or up to 100 wt. %, of total weight of the DCR. Aromatic DCR is defined as DCR species having a MW of 252-256, with MW of 254 as having a reactive double bond, and cycloaliphatic DCR is defined as DCR species having a MW of 260 or 262.

In embodiments, DCR has a C19 (MW 248-262) content of >50 wt. %, or >60 wt. %, or >70 wt. %, or >80 wt. %. In embodiments, the amount of cycloaliphatic DCR (MW 260 and 262) is >15 wt. %, or >20 wt. %, or >30 wt. %, or >40 wt. %, or >50 wt. %, or >80 wt. %, based on the total weight of the DCR.

In embodiments, total amount of tricyclic species having reactive double bond (C═C group) is <5 wt. %, <3 wt. %, <1 wt. %, or 0 wt. % of total weight of the DCR. Reactive C═C group is defined as DCR species having a MW of 254 or 258.

In embodiments, DCR has C19 species with MWs of 254, 250, and 248 in an amount of <5 wt. %, or <3 wt. %, or <1 wt. %, or <0.5 wt. %, or 0 wt. %.

In embodiments, DCR has a C13 species with MWs of 174 and 180 in an amount of 5-20 wt. %, or 5-15 wt. %, or >5 wt. % or <20 wt. %.

In embodiments after hydrogenation, the amount of tricyclic species having 18-20 carbon atoms in the hDCR goes up to at least 70 wt. %, or 70-100 wt. %, or 75-100 wt. %, or 75-95 wt. %, or 80-100 wt. %, or 80-95 wt. %, based on total weight of the hDCR.

In embodiments before hydrogenation, the unhydrogenated DCR contains C19 species with a MW of 262 in an amount of 1-25 wt. %, 5-20 wt. %, or 5-15 wt. %, <30 wt. %, or <25 wt. %, or <20 wt. %, or <15 wt. %. After hydrogenation, hDCR contains C19 species with a MW of 262 in an amount of 25-100 wt. %, or 35-100 wt. %, or 40-100 wt. %, or 25-90 wt. %, or 25-80 wt. %, or 40-75 wt. %, or 50-70 wt. %, or >25 wt. %, or >35 wt. %, or >50 wt. %, or >75 wt. %.

In embodiments before hydrogenation, the unhydrogenated DCR contains C19 species with a MW of 260 in an amount of 5-25 wt. %, or 10-20 wt. %, or >5 wt. %, or >10 wt. %, or >15 wt. %, or <20 wt. %. After hydrogenation, the hDCR contains C19 species with a MW of 260 in an amount of 0-5 wt. %, or 0-3 wt. %, or 0-1 wt. %, or <5 wt. %, or <2 wt. %, or 0 wt. %.

In embodiments before hydrogenation, the unhydrogenated DCR contains C19 species with a MW of 256 in an amount of 35-60wt. %, or 40-60 wt. %, or 35-55 wt. %, or 40-55 wt. %, or >37 wt. %, or >40 wt. %, or >45 wt. %. After hydrogenation the hDCR contains C19 species with a MW of 256 in an amount of 0-50 wt. %, or 0-40 wt. %, or 5-35 wt. %, or 10-30 wt. %, or <40 wt. %, or <30 wt. %.

In embodiments before hydrogenation, the unhydrogenated DCR contains C19 species with a MW of 252 in an amount of 5-20 wt. %, or 5-15 wt. %, >5 wt. %, or >10 wt. %. After hydrogenation, the hDCR contains C19 species with a MW of 252 in an amount of 0-5 wt. %, or 0-3 wt. %, or <5 wt. %, or <3 wt. %, or <1 wt. %, or 0 wt. %.

In embodiments before hydrogenation, the unhydrogenated DCR contains C13 species with a MW of 180 in an amount of 0-5 wt. %, or 0-3 wt. %, or <5 wt. %, or <2 wt. %, or <1 wt. %, or 0 wt. %. After hydrogenation, the hDCR contains C13 species with a MW of 180 in an amount of 0-25 wt. %, or 5-20 wt. %, or 5-15 wt. %, or >5 wt. %, or >7 wt. %, or >10 wt. %.

In embodiments before hydrogenation, the unhydrogenated DCR contains C13 species with a MW of 174 in an amount of 5-25 wt. %, 5-20 wt. %, or 5-15 wt. %, or >5 wt. %, or >10 wt. %, or <20 wt. %. After hydrogenation, the hDCR contains C13 species with a MW of 174 in an amount of 0-5 wt. %, or 0-3 wt. %, or <5 wt. %, of <2 wt. %, or 0 wt. %.

The MW of the species in unhydrogenated DCR and hDCR can be measured using any of MS, MS/GC/HPLC, and GC-MS. In an embodiment using the GC-MS method and column described above, the DCR and hDCR components and their associated MWs can be identified by the following retention profile (with ranges in minutes): MW of 174 g/mol, 7.0-8.5 minutes; MW of 180 g/mol, 2.5-4.0 minutes; MW of 248 g/mol, 32.5-34.5 minutes; MW of 250 g/mol, 26.0-31.0 minutes; MW of 252 g/mol, 24.5-31.0 minutes; MW of 254 g/mol, 16.5-25.0 minutes; MW of 256 g/mol, 16.5-25.0 minutes; MW of 260 g/mol, 11.0-16.0 minutes; and MW of 262 g/mol, 11.0-16.0 minutes. From the GC-MS retention profile above, the various DCR and hDCR components can be identified, e.g., species with a MW of 180 g/mol can be identified with a GC-MS peak in the range of 2.5-4.0 min., species with a MW of 256 g/mol can be identified in the range of 16.5-25.0 min., etc.

In the event of overlapping or identical retention time ranges for different DCR and hDCR components, the mass spectrum of each peak (as provided by the GC-MS) can be used to identify the molecular weight of the component, e.g., by comparing the mass spectra of the component with the mass spectra in reference databases like NIST or via library matching.

The species with the same molecular weights (isomers) are clustered and the total amount per isomer is reported.

In embodiments, the hDCR comprises at least 5 isomers, or 10 isomers, or 20 isomers, or 50 isomers, or 100 isomers of a species having a molecular formula of C19H34 and a MW of 262 g/mol.

In embodiments after hydrogenation, the hDCR comprises C═C double bonds in amounts of <40%, or <30%, or <20%, or <15%, or <10%, or <5%, or >1%, or 1-40%, or 2-20%, or 1-10%.

In embodiments after hydrogenation, the hDCR comprises an average Double Bond Equivalent in an amount of 0.1-2, or 0.2-1.5, or 0.5-1.4, or 0.5-2, or 0.01-1, or 0.05-0.9, or 0.08-0.8, or <2, or <1.8, or <1.5, or <1.2, or <1, or >0.1, or >0.01.

In embodiments, DCR is characterized as having a m/z (mass/charge) value in the range of 170-280, or 220-280, or 230-270, or 234-262, or 235-265, or >230, or <265, measured by GC-FID-MS.

In embodiments, DCR is characterized as having an oxygen content of <5%, or <3%, or <2%, or <0.9%, or <0.5, or <0.2%, or <0.1%, or 0-5%, or 0-3%, or 0-2%, or 0-1%.

The oxygen content (in %) can be calculated as oxygen to carbon ratio, or the sum of oxygen atoms present divided by sum of carbon atoms present, with the number of oxygen and carbon atoms being obtained from elemental analyses.

In embodiments, unhydrogenated DCR is characterized as having a lower acid value (carboxylic acid content) than the rosin acid feedstock for making the DCR. In embodiments, DCR has an acid value of <50, or <45, or <40, or <35, or <30, or <25, or <20, or <15, or <10, or <7, or <5, or 0.5-40, or 0.5-30, or 0.5-20, or 1-20, or 1-15, or 1-15, or 1-10 mg/KOH, as measured using ASTM D1240-14 (2018) or ASTM D465.

In embodiments, hDCR has an acid value of <10, or <8, or <5, or <2, or <1, or <0.8, or <0.5, or <0.2, or 0.01-10, or 0.1-5, or 0.01-0.2 mg KOH/g, as measured using ASTM D1240-14 (2018) or ASTM D465.

In embodiments, DCR has a density of 0.9-1.0, or 0.91-0.99, or 0.92-0.98, or 0.93-0.97, or 0.94-0.96, or >0.9, or <1.1 g/cm3.

In embodiments, DCR is characterized as having viscosities comparable to those of petrochemical base oils, due in part to its relatively high molecular weights, for example, a viscosity of 5-60, or 10-60, 15-60, or 5-60, or 10-55, or 10-50, or 15-50, or >5, or >10, or >15, or >20, or <50, or <60 cSt according to ASTM D-445, measured at 40° C.

In embodiments, unhydrogenated DCR has an aniline point of 3-40° C., or 5-40° C., or 5-30° C., or 5-25° C., or 2-20° C., or 5-20° C., or 5-15° C., or <25° C., or <20° C., or >3° C., or >5° C., or >8° C., according to ASTM D611.

In embodiments, hDCR has an aniline point of 20-80° C., 30-70° C., 30-60° C., 40-50° C., or >20° C., or >30° C., or >40° C., or <70° C., according to ASTM D611.

In embodiments, unhydrogenated DCR has a pour point of-40 to +10° C., or-35 to +8° C.,-30 to +5° C., or-30 to +0° C., or −30 to −5° C., or −28 to 0° C., or −28 to −5° C., or −28 to −10° C., or >−40° C., or >−30° C., or >−28° C., or <+5° C., or <+10° C., according to ASTM D97.

In embodiments, hDCR has a pour point of −40 to −10° C., or −35 to −20° C., or −35 to −25° C., or <0° C., or <−5° C., <−10° C., or >−40° C., or >−35° C., or according to ASTM D97.

In embodiments, unhydrogenated DCR has a flash point of 135-180° C. or 135-175° C., or 135-165° C., or 135-160° C., or 140-175° C., or 140-160° C., or 140-158° C., or 140- 155° C., or >135° C., or >140° C., or <175° C., or <165° C., or <160° C., according to ASTM D92.

In embodiments, hDCR has a flash point of 95-140° C., or 100-135° C., or 95-135° C., or <140° C., or <135° C., or >95° C., or >100° C., according to ASTM D92.

In embodiments, DCR has a boiling point of 200-390° C., or 210-390° C., or 235-390° C., or 280-380° C., or 290-370° C., or 300-360° C., or >290° C., or >230° C., or >210° C., or <400° C., or <370° C., measured according to ASTM D2887.

In embodiments, unhydrogenated DCR has a Gardner Color of 0-12.0, or 0.5-12.0, or 0.8-12.0, or 0.9-11, or 1.0-10.0, or 1.0-6.0, or 1.0-5, or >0, or >1.0, or >1.2, or <10.0, or <7.0, or <6.0, or <5.0, or <2.4, or <3.0, according to ASTM D6166.

In embodiments, hDCR has a Gardner Color of <1, or <0.8, or <0.5, or <0.2, or 0.1-1, or 0.15-0.8, or 0.1-0.5, according to ASTM D6166.

In embodiments, unhydrogenated DCR has a sulfur content of <500 ppm (0.05 wt. %), or <300 ppm (0.03 wt. %), or <200 ppm (0.02 wt. %), or <100 ppm (0.01 wt. %), or <10 ppm (0.001 wt. %), or 20-700 ppm (0.002-0.7 wt. %), 30-500 ppm (0.003-0.5 wt. %), or 40-400 ppm (0.004-0.4 wt. %), or 40-300 ppm (0.004-0.3 wt. %), or 40-200 ppm (0.004-0.2 wt. %), based on total weight of the DCR, measured according to ASTM D5453.

In embodiments, hDCR has a sulfur content of 0.001-10 ppm, or 0.001-5 ppm, or <10 ppm, or <8 ppm, or <5 ppm, or >0.001 ppm, measured according to ASTM D5453.

In embodiments, DCR has a VOC of <5, or <4.75, or <4.5, or <4.25, or <4.0, or <3.75, or <3.5, or <3.25, or <3.0, or <2.75, or <2.5, or <2.25, or <2.0, or <1.5, or <1.0, or <0.5 wt. %, based on total weight of the DCR. The VOC of DCR is measured according to methods: i) summing the percent by weight contribution from all VOCs present in the product at 0.01% or more, or ii) according to the EPA (Environmental Protection Agency) method 24 or equivalent.

In embodiments, DCR has a Kb (Kauri butanol) value of 25-90, or 30-85, or 35-80, or 40-75, or 45-70, or 50-65, or >40, or >50, or >60, or >70, or >80, according to ASTM D1133.

In embodiments, unhydrogenated DCR has a viscosity index of >-200, or-200 to −50, or <0, or <−50, measured according to ASTM D2270. In embodiments, hDCR has a viscosity index of <25, or <0, or −50 to 0, or >−50, measured according to ASTM D2270. The viscosity index is an arbitrary, unit-less measure of a fluid's change in viscosity relative to temperature change, for example, index of viscosity at 40° C. and viscosity at 100° C.

In embodiments, DCR has a δD value of 14-18, or 14.2-17.8, or 14.5-17.5, or 15-17, or 15.2-16.5; a δP value of 3-6, or 3.2-5.5, or 3.4-5.2, or 3.5-5.0; and δH value of 7-10, or 7.5-9.5, or 8-9, or 8.2-8.8.

In embodiments, unhydrogenated DCR has a surface tension of 25-50, or 28-45, or 30-40 dynes/cm, according to ASTM D1331.

In embodiments, DCR is used in a drift control adjuvant in an amount of 50-95 wt. %, 55-95 wt. %, or 60-95 wt. %, based on the total weight of the drift control adjuvant, with the remainder being surfactant, and/or optional components.

In embodiments, where DCR is a replacement for oil in crop oil concentrate (“COC”) and methylated seed oil (“MSO”) adjuvant formulations, DCR is present in an amount of 60-95 wt. %, or 75-95 wt. %, based on the total weight of the adjuvant, with the remainder being surfactant, and/or optional components.

In embodiments, where DCR is a replacement for oil in high surfactant oil concentrate (“HSOC”) adjuvant formulations, DCR is present in amounts from 50-80 wt. %, or 50-70 wt. %, or 55-65 wt. %, based on the total weight of the adjuvant, with the remainder being surfactant, and/or optional components.

In embodiments, DCR is used as a drift control agent by itself and added directly to an agricultural spray composition in an amount of 0.01-0.75% v/v, 0.01-0.6% v/v, 0.01-0.5% v/v, 0.01-0.4% v/v, 0.015-0.3% v/v, 0.015-0.2% v/v, 0.0175-0.1% v/v, 0.05-0.6% v/v, 0.06-0.6% v/v, or 0.07-0.57% v/v, based on the total volume of the agricultural spray composition (diluted with carrier). The agricultural spray composition itself may or may not contain any surfactant.

In embodiments, the drift control adjuvant containing DCR is added to agricultural spray compositions in an amount of 0.02 to 5.0% v/v, or 0.05-3% v/v, 0.05-2% v/v, 0.75-2% v/v, 0.25-3% v/v, 0.3-2.5% v/v, or 0.5-2% v/v, based on the total volume of the agricultural spray composition (diluted with carrier).

Surfactant System: The surfactant system can be included directly in the spray composition and/or supplied as part of the drift control adjuvant. The surfactant system can aid in dispersing the DCR in liquid, stabilizing the concentrate composition, and optionally enhancing spreading or deposition of spray droplets on plant surfaces. The surfactant system can be a single surfactant, or a mixture of two or more surfactants selected from nonionic, anionic, cationic, amphoteric surfactants, and mixtures thereof. In embodiments, the surfactant comprises at least a nonionic surfactant, optionally in combination with an anionic surfactant.

In embodiments, the nonionic surfactant (which includes a blend of surfactants) has a Hydrophilic Lipophilic Balance (HLB) 2-18, or 3-18, or 3-15, or 5-15, or 8-15, or 3-13. Surfactants with an HLB of 8-15 may be particularly suitable for dispersing DCR in aqueous systems.

In embodiments, the nonionic surfactant comprises, consists essentially of, or consists of one or more of ethoxylates, fatty acid derivatives, block copolymers, alkyl polyglucosides, and mixtures thereof.

In embodiments, the nonionic surfactant is an ethoxylate selected from alcohol ethoxylates, fatty alcohol ethoxylates, alkylphenol ethoxylates, fatty acid ethoxylates, ethoxylated amines, and mixtures thereof. In embodiments, the nonionic surfactant is selected from alkylphenol ethoxylates, fatty acid ethoxylates, and mixtures thereof. Examples of ethoxylated surfactants include nonoxynol-9, lauryl alcohol ethoxylates, octaethylene glycol monododecyl ether, pentaethylene glycol monododecyl ether, nonylphenol ethoxylates, octylphenol ethoxylates, nonoxynol, Triton X-100, stearic fatty acid ethoxylates, oleic fatty acid ethoxylates, lauryl fatty acid ethoxylates, polyethoxylated tallow amine, cocoamine ethoxylates, tallowamine ethoxylates, and mixtures thereof. In embodiments, when the ethoxylate is a nonylphenol ethoxylate, the degree of ethoxylation ranges from 1-40, or 1-30, or 1-20, or 2-10 moles of ethylene oxide per mole of nonylphenol.

In embodiments, the nonionic surfactant is fatty acid derivative selected from fatty acid amides, fatty acid esters of glycerol, fatty acid esters of sorbitol, fatty acid esters of sucrose, and mixtures thereof. Examples of fatty acid amide and ester surfactants include cocamide monoethanolamine, cocamide diethanolamine, glycerol monostearate, glycerol monolaurate, sorbitan monolaurate, sorbitan monostearate, sorbitan tristearate, sucrose stearate, sucrose palmitate, sucrose laurate, sucrose cocoate, sucrose oleate, sucrose myristate, sucrose behenate, and mixtures thereof.

In embodiments, the nonionic surfactant is a block copolymer surfactant selected from poloxamers, tetronics, polysorbates, polyethylene glycol (PEG) copolymers, polypropylene glycol (PPG) copolymers, PEG-PPG copolymers, PEG-polyester block copolymers, and mixtures thereof. Examples of block copolymer surfactants include ethylene oxide/propylene oxide block copolymers, block copolymers consisting of PEG and sorbitan esters, copolymers of alternating PEG and PPG units, copolymers of PEG blocks linked with polyester blocks such as polycaprolactone or polylactic acid.

In embodiments, the nonionic surfactant is an alkyl polyglucoside, such as decyl glucoside, lauryl glucoside, and octyl glucoside.

In embodiments, the anionic surfactant is selected from sulfate, sulfonate, phosphate and carboxylate surfactants. Anionic surfactants can be used in free acid form or in neutralised form, such as salt forms including ammonium, organic amine, magnesium, potassium and sodium salt forms. Examples include alkyl sulfates (such as sodium lauryl sulfate and sodium dodecyl sulfate); alkyl ether sulfates (such as sodium laureth sulfate and sodium myreth sulfate); sulfosuccinates (such as sodium dioctyl sulfosuccinate); alkylbenzene sulfonates (such as dodecylbenzene sulfonate and dodecyl diphenyl ether disulfonate); aryl-alkyl ether phosphates; alkyl ether phosphates; and alkyl carboxylates (such as sodium stearate, sodium laurate, and sodium lauroyl sarcosinate). Hydrocarbon sulfonates such as alpha-olefin sulfonates and secondary alkane sulfonates can also be used.

In embodiments, the cationic surfactant is selected from quaternary ammonium compounds or pH-dependent amines. Examples include alkyl quaternary ammonium compounds such as: behentrimonium chloride, benzalkonium chlorides (BAC) including dimethylbenzyl ammonium chloride, cetalkonium chloride (CKC) and stearalkonium chloride, benzethonium chloride, benzododecinium chloride, carbethopendecinium bromide, cetrimonium bromide (CTAB), cetrimonium chloride (CTAC), cetylpyridinium chloride (CPC), didecylmethylammonium chloride, dimethyldioctadecylammonium bromide (DODAB), dimethyldioctadecylammonium chloride, domiphen bromide, octenidine dihydrochloride, and thonzonium bromide.

In embodiments, the amphoteric surfactant contains both acidic and basic functional groups, enabling the surfactant to act as cationic or anionic depending on pH. Amphoteric surfactants can be zwitterionic. Examples of amphoteric surfactants include alkyl amine oxides such as lauramine oxide and myristamine oxide; betaines such as cocamidopropylbetaine; hydroxysultaines such as lauramidopropyl hydroxysultaine, cocamidopropyl hydroxysultaine, oleimidopropyl hydroxysultaine, tallowamidopropyl hydroxysultaine, erucamidopropyl hydroxysultaine, and lauryl hydroxysultaine; and amphoacetates such as sodium lauramphoacetate.

In embodiments, the surfactant system further comprises a fatty acid as a co-surfactant. Tall oil fatty acid (TOFA) is one example and can function both as a co-surfactant and a compatibility enhancer for DCR with ethoxylated surfactants. In embodiments where the fatty acid co-surfactant is present, the surfactant: fatty acid ratio ranges from 1:10 or 10:1, or 1:8 to 8:1, or 1:6 to 6:1, or 1:4 to 4:1, or 1:3 to 3:1, 1:2 to 2:1, or about 1:1.

In embodiments, the surfactant system is present in the drift control adjuvant in an amount of 5-50 wt. %, or 5-45 wt. %, or 5-40 wt. %, based on the total weight of the drift control adjuvant.

Optional Components: The optional components can be included directly in the spray composition and/or supplied as part of the drift control adjuvant. The drift control adjuvant can further comprise optional components which may serve to stabilize the formulation, improve handling properties, or extend shelf-life. Such optional components may include additional surfactants, solvents, defoamers, antimicrobials, preservatives, stabilizers, buffering agents, antioxidants, rheology modifiers, or other formulation aids.

Stabilizing agents can include additional surfactants that improve dispersion or compatibility of DCR with other formulation ingredients. Examples include linear or branched alkylbenzene sulfonates, ethoxylated fatty alcohols, ethoxylated castor oils, ethoxylated/propoxylated alcohols and copolymers, ethoxylated fatty acids, sorbitan esters, polysorbates, ethoxylated fatty amines, ethoxylated tristyrylphenols, ethoxylated phosphate esters, ethanolamides, ethoxylated nonylphenols, tallow amine ethoxylates, tallow amines, naphthalene sulfonate-formaldehyde condensates, alcohol alkoxylates, and tristyrylphenol alkoxylates. Resins or other polymers may also be included to enhance physical stability.

Inert components may be used to aid formulation, handling, or storage. Examples include solvents such as isopropyl alcohol and/or isobutyl alcohol, or propylene glycol which can act as diluents or freezing point depressants. Other inert components can include polysiloxane foam suppressants, present in an amount of 0.001-1.0% (v/v), or antimicrobials such as 1,2-benzisothiazolin-3-one in dipropylene glycol, present in an amount of 0.01-0.25% (v/v).

In embodiments, optional components are present in an amount of 1-20 wt. %, 1-10 wt. %, or 1-5 wt. %, based on the total weight of the drift control adjuvant composition.

Properties of Drift Control Adjuvant: In embodiments, drift control adjuvant compositions at 0.02-5% v/v, or 0.05-4% v/v, 0.01-3% v/v, or 0.25-2% v/v, or 0.5-1.5% v/v, or 0.5-1% v/v in a carrier (e.g., water), have a volume mean diameter (“VMD”) of 320-420 um, or 330-410 μm, or 335-405 μm, or >300 μm, or >325 μm, or >330 μm, or >335 μm, or <450 um, or <425 μm, or <410 μm, which is at least 2%, 5%, 7%, or 10% greater than that of a corresponding composition lacking DCR.

In embodiments, drift control adjuvant compositions at 0.02-5% v/v, or 0.05-4% v/v, 0.01-3% v/v, or 0.25-2% v/v, or 0.5-1.5% v/v, or 0.5-1% v/v in a carrier, have a Draves Wetting Time of <125 seconds, or <120 seconds, or <115 seconds, according to ASTM D2281.

In embodiments, drift control adjuvant compositions, when diluted in a carrier, exhibit spray coverage of 30-50%, or 35-45%. In embodiments, spray coverage is increased by at least 5%, 10%, 15%, or 20% compared to water.

In embodiments, drift control adjuvant compositions exhibit droplet quantity of 3,000-5,000 droplets per unit area, or 3,200-4,800 droplets per unit area, or 3,500-4,500 droplets per unit area.

In embodiments, drift control adjuvant compositions exhibit a diameter coefficient of 60-80%, or 65-75%, or 67-73%.

In embodiments, drift control adjuvant compositions at 0.02-5% v/v, or 0.05-4% v/v, 0.01-3% v/v, or 0.25-2% v/v, or 0.5-1.5% v/v, or 0.5-1% v/v in a carrier, have a surface tension of <40 dynes/cm, or >25 dynes/cm, or >30 dynes/cm, or 25-40 dynes/cm, or 30-40 dynes/cm, or 30-35 dynes/cm, according to ASTM D1331.

In embodiments, drift control adjuvant compositions at 0.02-5% v/v, or 0.05-4% v/v, 0.01-3% v/v, or 0.25-2% v/v, or 0.5-1.5% v/v, or 0.5-1% v/v in a carrier, have a Brookfield viscosity of >125 cP, or <300 cP, or 140-300 cP, or 140-280 cP, according to ASTM D2196.

Agricultural Chemical: The agricultural sprays include agricultural chemical components selected from the group of pesticides, growth regulators, micronutrients, and fertilizers. Pesticides include herbicides, insecticides, fungicides, rodenticides, bactericides, nematicides, algaecides, or mixtures thereof.

Suitable herbicides include both selective and non-selective herbicides, such as bicyclopyrone, mesotrione, fomesafen, glyphosate, tralkoxydim, napropamide, propanil, flamprop-M, 2,4-D, MCPA, mecoprop, clodinafop-propargyl, cyhalofop-butyl, diclofop-methyl, haloxyfop, quizalofop-P, isoxaben, tebutam, chlorthal-dimethyl, benfuresate, dicamba, dichlobenil, benazolin, triazinone herbicides (e.g., metribuzin), phenmedipham, acetochlor, alachlor, metolachlor, pretilachlor, thenylchlor, alloxydim, butroxydim, clethodim, cycloxydim, sethoxydim, tepraloxydim, pendimethalin, dinoterb, bifenox, oxyfluorfen, acifluorfen, fluoroglycofen-ethyl, bromoxynil, ioxynil, imazamethabenz-methyl, imazapyr, imazaquin, imazethapyr, imazapic, imazamox, flumioxazin, flumiclorac-pentyl, picloram, amidosulfuron, chlorsulfuron, nicosulfuron, rimsulfuron, triasulfuron, triallate, pebulate, prosulfocarb, molinate, atrazine, simazine, cyanazine, ametryn, prometryn, terbuthylazine, terbutryn, sulcotrione, isoproturon, linuron, fenuron, chlorotoluron, metoxuron, and mixtures thereof.

Suitable fungicides include strobilurins, triazoles, dithiocarbamates, and others, such as isopyrazam, mandipropamid, azoxystrobin, trifloxystrobin, kresoxim-methyl, famoxadone, metominostrobin, picoxystrobin, cyprodinil, carbendazim, thiabendazole, dimethomorph, vinclozolin, iprodione, dithiocarbamates, imazalil, prochloraz, fluquinconazole, epoxiconazole, flutriafol, azaconazole, bitertanol, bromuconazole, cyproconazole, difenoconazole, hexaconazole, paclobutrazole, propiconazole, tebuconazole, triadimefon, triticonazole, fenpropimorph, tridemorph, fenpropidin, mancozeb, metiram, chlorothalonil, thiram, ziram, captafol, captan, folpet, fluazinam, flutolanil, carboxin, metalaxyl, bupirimate, ethirimol, dimoxystrobin, fluoxastrobin, orysastrobin, prothioconazole, and mixtures thereof.

Suitable insecticides include pyrethroids, organophosphates, neonicotinoids, carbamates, insect growth regulators, and mixtures thereof. Examples include lambda-cyhalothrin, cypermethrin, deltamethrin, malathion, chlorpyrifos, imidacloprid, clothianidin, thiamethoxam, carbaryl, methomyl, methoprene, pyriproxyfen, acetamiprid, dinotefuran, nitenpyram, fipronil, abamectin, emamectin, bendiocarb, fenoxycarb, isoprocarb, pirimicarb, propoxur, xylylcarb, asulam, chlorpropham, endosulfan, heptachlor, tebufenozide, bensultap, diethofencarb, pirimiphos-methyl, aldicarb, bioallethrin, cyfluthrin, fenvalerate, imiprothrin, permethrin, halfenprox, and mixtures thereof.

Methods for Reducing Spray Drift: In embodiments, a method for reducing spray drift during agricultural spraying comprises, consists essentially of, or consists of incorporating a drift control agent comprising decarboxylated rosin acid (DCR), either directly or as part of a drift control adjuvant formulation, into an agricultural spray composition, and applying the spray composition to an agricultural locus. The method encompasses any spraying process in which the presence of DCR reduces the formation or off-target movement of fine spray droplets. The agricultural spray composition can be prepared by any suitable method, including, without limitation, (i) a premix (concentrate) route and (ii) a tank-mix route as described below.

Premix (Concentrate) Route: In embodiments, the drift control adjuvant is combined with a concentrated agricultural chemical component to provide a concentrate composition, and the concentrate composition is diluted with a carrier to provide the agricultural spray composition, the dilution being sufficient to provide 0.02-5.0% v/v of the drift control adjuvant and 95.0-99.98% v/v of the agricultural chemical component in the agricultural spray composition. In embodiments where the agricultural chemical component comprises an agricultural chemical active ingredient and a carrier, the active ingredient is present at 0.1-2.0% v/v of the agricultural spray composition.

Tank-mix route: In embodiments, a concentrated agricultural chemical component is first diluted with a carrier to provide a diluted agricultural chemical composition, after which the drift control adjuvant is added to provide the agricultural spray composition; in embodiments the agricultural spray composition comprises 0.02-5.0% v/v of the drift control adjuvant and 95.0-99.98% v/v of the agricultural chemical component. In embodiments where the agricultural chemical component comprises an agricultural chemical active ingredient and a carrier, the active ingredient is present at 0.1-2.0% v/v of the agricultural spray composition.

In embodiments, the method is carried out using any agricultural spray equipment, including but not limited to ground sprayers, aerial sprayers, or electrostatic sprayers, and with any nozzle type suitable for spraying.

The method is applicable across a wide range of spraying conditions, including but not limited to spray pressures of 10-200 psi, spray volumes of 1-50 gallons per acre, ground speeds of 1-15 miles per hour, aerial boom heights of 3-30 feet, and aerial airspeeds of 50-200 miles per hour. In embodiments, the method is effective with agricultural compositions comprising one or more agricultural chemical components such as herbicides, insecticides, fungicides, fertilizers, micronutrients, or plant growth regulators, and a DCR-containing drift control adjuvant. The DCR-containing adjuvant may be used alone or in combination with other adjuvants, and the drift-reducing properties are retained in typical tank mixes.

Properties for Agricultural Spray Compositions: Agricultural spray compositions containing the drift control adjuvant exhibit improved spray characteristics compared to spray mixtures without DCR.

In embodiments, agricultural spray compositions containing a DCR drift control adjuvant exhibit a volume mean diameter (VMD) of 215-430 μm, or 225-425 μm, or 230-420 μm, or >225 μm, or >230 μm, or <450 μm, or <425 μm. In embodiments, the VMD is at least 5%, 7%, 10%, 15%, or 20% greater than the VMD of water-only control spray under the same nozzle and pressure conditions.

In embodiments, agricultural spray compositions containing DCR exhibit a VMD of at least 2%, 5%, 7%, or 10% compared to spray compositions containing another adjuvant formulation lacking DCR.

In embodiments, agricultural spray compositions containing a DCR drift control adjuvant exhibit a reduction in percent fines (<141 μm) from 2-25%, or 2-22%, or >2%, or >2.5%, or <25%, or <20% of total spray volume, depending on nozzle type. This corresponds to a reduction of at least 10%, 15%, 20%, 25%, or 30% compared to water, and of at least 5%, 10%, or 15% compared to a spray composition containing another adjuvant without DCR.

In embodiments, agricultural spray compositions containing DCR exhibit a relative span of 0.9-1.5, or 0.9-1.4, or 0.95-1.3, or 1.0-1.3, indicating a narrower and more uniform droplet size distribution compared to water alone or adjuvants without DCR.

In embodiments, spray droplets formed from the agricultural spray composition exhibit a volume mean diameter (VMD) of 215-430 μm, a fines fraction (<141 μm) of 2-25% of total spray volume, and/or a relative span of 0.9-1.5.

In embodiments, agricultural spray compositions containing DCR-based drift control adjuvants exhibit spray coverage that is maintained or increased relative to water-only spray controls, while simultaneously reducing the proportion of drift-prone droplets.

Collectively, these properties demonstrate that incorporation of DCR into drift control adjuvant formulations improves the quality of agricultural spray applications by reducing drift-prone fines, increasing droplet size (VMD), and enhancing uniformity of droplet distribution while maintaining effective spray performance.

Applications: The drift control agent and drift control adjuvant compositions containing DCR can be used in connection with agricultural spray applications directed to any locus of an agricultural target, including seeds, soil, foliage, trees, forests, or fruit. Sprays containing the disclosed drift control agent or drift control adjuvant can be delivered using ground and/or aerial spray applications. Applications may occur during the vegetative stage, at planting, or after planting, in order to reduce spray drift while maintaining effective spray coverage.

Analytical Methods: Unless indicated otherwise, concentrations in agricultural spray compositions are expressed as % v/v relative to the final spray solution volume;

composition of the drift control adjuvant (internal formulation) is expressed as wt. %. All testing is performed at ambient laboratory temperature (typically 20-25° C.) unless otherwise specified.

Molecular weight (MW) of compounds, components, or species in a compound can be determined by MS (mass spectroscopy), preferably in combination with a chromatographic separation method like GC (gas chromatography) or HPLC (high performance liquid chromatography). In embodiments, the MW is determined by GC-MS, using a column with a highly-substituted cyanopropyl phase (e.g. Supelco SP-2330, Restek Rtx-2330, or Agilent HP-88) of the size 30 m×0.25 mm×0.20 μm, with the following operating parameters: a temperature profile of 100° C. for 5.0 min, heating with 5° C./min to 250° C. and holding this temperature for 10.00 min; forming a solution with 10 mg of compound in 1 ml of a suitable solvent such as toluene, cyclohexane, etc.; injecting 1 μl of the solution with a split ratio of 1:40 at 250° C.; maintaining the flow at 1 ml/min throughout the analysis. Identification of the individual components is performed by QMS (quadrupole mass spectrometry) detector, with an ion source temperature of 200° C. and a mass range of 35-500 amu.
Examples: The following illustrative examples are non-limiting.
Coverage (%): percentage of the surface area covered by droplets.
Droplet quantity: total number of droplets detected on the spray card.
Diameter coefficient (%): a statistical measure related to droplet size distribution.
Droplet size parameters: expressed in terms of volume-based percentiles of the cumulative droplet size distribution:
   DV10 is the droplet diameter below which 10% of the spray volume is contained.
   DV50 is the droplet diameter below which 50% of the spray volume is contained (i.e., the median droplet diameter by volume). DV50 is also referred to in the art as the volume mean diameter (“VMD”), and the terms are used interchangeably herein.
   DV90 is the droplet diameter below which 90% of the spray volume is contained.
Relative Span: a measure of the uniformity of the droplet size distribution, calculated as:

$$Relative Span = \frac{DV 90 - DV 10}{DV 50}$$

In the examples below, a smaller Relative Span indicates a narrower, more uniform droplet size distribution. In general, spray solutions with a larger DV50 (coarser median droplet size) and a smaller proportion of droplets below 141 μm exhibit reduced drift potential.

Draves Wetting Time is determined by the Draves Test per ASTM D2281.

Surface tension is determined using a Kruss Force Tensiometer standard plate surface tension test (ASTM D1331).

Viscosity is Brookfield viscosity and determined using a Brookfield DV1 viscometer with a spindle type 18, 20 RPM and 20° C. (ASTM D2196).

In the following examples, formulations were prepared and tested using a drift control agent (DCR) as described below. DCR sample is from Kraton Corporation with properties as shown in Table 1. Additionally, the sample also has the following: %O2 content of 0.39; % tricyclic compounds of 69.5, aromatic MW252 of 15.7; reactive double bond MW 254 of 0.1; aromatic MW256 of 40.3; reactive double bond MW 258 of 0.4; and cycloaliphatic MW260 of 0.7.

TABLE 1
DCR Sample

| | DCR 1 |
|---|---|
| Acid Number mg KOH/g | 12 |
| Gardner Color | 12 |
| Viscosity, cSt @ 40° C. | 45 |
| Density, 20° C. (g/cm³) | 0.97 |
| Flash Point, COC (° C.) | 145 |
| Aniline Point (° C.) | 13 |
| Pour Point (° C.) | −14 |
| Kb value | — |
| δD value | 16.3 |
| δP value | 3.6 |
| δH value | 8.5 |

Example 1: In Example 1, drift control adjuvant formulations were prepared in which the oil component of conventional adjuvant systems was replaced with decarboxylated rosin acid (DCR). Specifically, DCR was substituted for soy methyl ester oil in methylated seed oil adjuvants (DCA 1A below), for paraffinic oil in crop oil concentrate adjuvants (DCA 2A below), and for soy methyl ester in high surfactant oil concentrate adjuvants (DCA 3A below). Comparative formulations without DCR (labeled as DCA 1, DCA 2, DCA 3 below) were also prepared and analogous DCR-substituted versions of commercial adjuvant packages (e.g., Tolex ME8470 as DCA 1B and Tolex 8317 as DCA 2B) were evaluated. In addition to DCR, the following components are also used:
NP-6 is a nonylphenol ethoxylate surfactant having 6 ethylene oxide units.
TOFA is a tall oil fatty acid having a long carbon chain (C18) with an acid number of 196 mgKOH/g, a Gardner color of 3, and % rosin acids of 0.8.
Drift Control Adjuvant 1 (“DCA 1”) is a methylated seed oil (“MSO”) adjuvant package, having 90 wt. % soy methyl ester oil, 5 wt. % NP-6, and 5 wt. % TOFA.
Drift Control Adjuvant 1A (“DCA 1A”) is replaces the soy methyl ester oil in DCA 1 with DCR.
Drift Control Adjuvant 1B (“DCA 1B”) replaces soy methyl ester oil with DCR in Tolex ME8470, a commercially available MSO adjuvant package, having 90 wt. % soy methyl ester oil and 10 wt. % surfactant, e.g., a fatty acid ethoxylate.
Drift Control Adjuvant 2 (“DCA 2”) is a crop oil concentrate (“COC”) adjuvant package, having 83 wt. % paraffinic oil, 8.5 wt. % NP-6, and 8.5 wt. % TOFA.
Drift Control Adjuvant 2A (“DCA 2A”) replaces the paraffinic oil in DCA 2 with DCR.
Drift Control Adjuvant 2B (“DCA 2B”) replaces paraffinic oil with DCR in Tolex 8317, a commercially available COC adjuvant package, having 83 wt. % paraffinic oil, and 17 wt. % surfactant, e.g., a fatty acid ethoxylate.
Drift Control Adjuvant 3 (“DCA 3”) is a high surfactant oil concentrate (“HSOC”) adjuvant package, having 60 wt. % soy methyl ester, 20 wt. % NP-6, and 20 wt. % TOFA.
Drift Control Adjuvant 3A (“DCA 3A”) replaces the soy methyl ester in DCA 3 with DCR.
Drift control adjuvant compositions are prepared by mixing the oil and surfactant(s) using a paddle blender. Characteristics and properties of the drift control compositions are obtained on a mixture of the drift control adjuvants in water at 1% v/v, or 0.5% v/v as indicated in the table below. The adjuvant package compositions above have the characteristics/properties listed in Tables 2 as follows.

TABLE 2
Properties of drift control adjuvant compositions in water at 1% v/v or 0.5% v/v

| | COC Formulations | | MSO Formulations | | HSOC Formulations | |
|---|---|---|---|---|---|---|
| | DCA 2A | DCA 2 | DCA 1A | DCA 1 | DCA 3A | DCA 3 |
| Properties | (@ 1% v/v) | (@ 1% v/v) | (@ 1% v/v) | (@ 1% v/v) | (@ 0.5% v/v) | (@ 0.5% v/v) |
| pH with 342 | 5.7 | 5.5 | 5.7 | 5.7 | 5.4 | 5.6 |
| ppm water | | | | | | |
| Draves | 53 | 49 | 97 | 47 | 111 | 58 |
| Wetting (s) | | | | | | |
| Surface | 32.7 | 30.4 | 32.8 | 31.5 | 32.4 | 31.3 |
| Tension | | | | | | |
| (Dynes/cm) | | | | | | |
| Viscosity | 232 | 11.9 | 272 | 7.92 | 149 | 13.4 |
| (cP) | | | | | | |

Droplet size analysis was performed in a spray chamber with a TP4001 nozzle (40 psi, 4 mph) using a volume of 15 gallons per acre (GPA). Spray Cards (SpotOn) were analyzed with DropScope. There were 4 passes per treatment and each pass utilized 3 spray cards placed equidistant on the center of the spray chamber bench.

TABLE 3
Droplet size analysis

| | | | | | | | |
|---|---|---|---|---|---|---|---|
| | | | Diameter | | | | |
| | Coverage | Droplet | Coefficient | Drift | VMD | | |
| Treatment | (%) | Quantity | (%) | Potential | (μm) | DV10 | DV90 |

Control without Adjuvant

| | | | | | | | |
|---|---|---|---|---|---|---|---|
| Water | 26.8 | 4076.6 | 70.8 | 2.10 | 306.5 | 164.1 | 445.8 |

Crop Oil Concentrate Formulations

| | | | | | | | |
|---|---|---|---|---|---|---|---|
| DCA 2A | 39.9 | 4256.4 | 67.5 | 1.00 | 342.4 | 192.8 | 522.0 |
| DCA 2 | 38.6 | 4823.3 | 65.4 | 1.28 | 318.5 | 177.5 | 484.3 |
| DCA 2B | 35.3 | 4392.3 | 69.9 | 1.07 | 352.7 | 193.9 | 548.5 |

Modified Seed Oil Formulations

| | | | | | | | |
|---|---|---|---|---|---|---|---|
| DCA 1A | 44.1 | 3473.3 | 72.3 | 0.66 | 404.8 | 224.5 | 601.9 |
| DCA 1 | 42.7 | 4142.2 | 68.3 | 0.83 | 363.1 | 203.6 | 549.7 |
| DCA 1B | 41.1 | 4416.7 | 70.1 | 1.00 | 356.0 | 195.3 | 550.1 |

High Surfactant Oil Concentrate Formulations

| | | | | | | | |
|---|---|---|---|---|---|---|---|
| DCA 3A | 37.0 | 4213.6 | 67.5 | 1.12 | 335.5 | 186.2 | 505.1 |
| DCA 3 | 39.7 | 4635.3 | 70.4 | 1.15 | 344.6 | 191 | 525.6 |
| LSD | 5.09 | 163.9 | 1.27 | 0.14 | 9.8456 | 5.00 | 12.80 |
| P | 0.0001 | 0.0001 | 0.0001 | 0.0001 | 0.0001 | 0.0001 | 0.0001 |

LSD: least significant difference
P-value = 0.0001 for all parameters tested.

Example 2: In Example 2, drift control adjuvant formulations containing DCR

were evaluated in spray solutions of a glyphosate herbicide (Roundup PowerMax 3). The DCR-containing adjuvants were prepared with surfactants such as tallow amine ethoxylate (TAM-8) or a combination of nonylphenol ethoxylate (NP-6) and tall oil fatty acid (TOFA)—formulations are found in Table 4 below. The formulations were tested at varying use rates and compared to commercial drift control agents including Polytex L 550, Interlock, and Polytex A 1010. Spray droplet size distributions were measured under controlled wind tunnel conditions to assess the effect of DCR-containing adjuvants on drift reduction. The same DCR from Example 1 was used, in addition to the following components:
Polytex L 550, from Exacto Inc., is a deposition aid.
Interlock, from Winfield United, is a drift control agent containing methylated seed oil and polyoxyethylene sorbitan fatty acid ester vegetable oil.
Polytex A 1010, from Exacto Inc., is a polyacrylamide based anion drift reduction agent.
TAM-8 is a POE (8) tallow amine (emulsifier).
NP-6 is a nonylphenol ethoxylate surfactant having 6 ethylene oxide units.
TOFA is a tall oil fatty acid having a long carbon chain (C18) with an acid number of 196 mgKOH/g, a Gardner color of 3, and % rosin acids of 0.8.
Herbicide is Roundup Power Max 3 a glyphosate herbicide.

Spray solutions were prepared by diluting Herbicide to a final concentration of 1.72% v/v (17.2 mL/L) in water. Drift control adjuvant compositions were added to the spray solution at concentrations ranging from 0.08% to 0.63% v/v (0.8-6.3 mL/L). Percent v/v is relative to the final spray solution volume. All compositions were prepared by direct addition of the adjuvant into the diluted herbicide spray solution with mixing until homogeneous. 5

Spray characterization was conducted using a Sympatec Helos Vario KR particle size analyzer in a low-speed wind tunnel. The nozzle plume was scanned across the analyzer beam using a linear actuator. Test conditions: 15 mph wind speed, 72.5° F. temperature, 53.8% relative humidity, 40 psi nozzle pressure, 12 in. measurement distance. Each treatment was replicated three times. Spray trials were performed using an XR11003 nozzle (a 110° extended-range flat-fan nozzle, TeeJet Technologies) and an AIXR11003 nozzle (a 110° air-induction extended-range flat-fan nozzle, TeeJet Technologies).

TABLE 4
Spray Analysis of Agricultural Chemical

| | | | Adjuvant | | | |
|---|---|---|---|---|---|---|
| | | Adjuvant | Use-Rate | DV50* | Relative | Pct <141 |
| Nozzle | Description | (% v/v) | (mL/L) | (μm) | Span | μm |
| XR11003 | Control (No Adjuvant) | 0 | 0 | 218 | 1.34 | 24.1 |
| | POLYTEX L 550 | 0.31 | 3.1 | 265 | 1.01 | 10.3 |
| | Interlock | 0.31 | 3.1 | 260 | 1.03 | 11 |
| | POLYTEX A 1010 | 0.5 | 5 | 221 | 1.32 | 23.4 |
| | DCR (88 wt. %) + | 0.63 | 6.3 | 232 | 1.26 | 20.1 |
| | TAM-8 (12 wt. %) | 0.31 | 3.1 | 251 | 1.13 | 14.3 |
| | | 0.16 | 1.6 | 258 | 1.07 | 12.1 |
| | | 0.08 | 0.8 | 255 | 1.06 | 12.4 |
| | DCR (90 wt. %) + | 0.63 | 6.3 | 259 | 1.09 | 12.7 |
| | NP-6 (5 wt. %) + | 0.31 | 3.1 | 258 | 1.09 | 12.6 |
| | TOFA (5 wt. %) | 0.16 | 1.6 | 260 | 1.08 | 12.2 |
| | | 0.08 | 0.8 | 257 | 1.1 | 12.7 |
| AIXR11003 | Control (No Adjuvant) | 0 | 0 | 347 | 1.25 | 8.1 |
| | POLYTEX L 550 | 0.31 | 3.1 | 413 | 0.99 | 2.2 |
| | Interlock | 0.31 | 3.1 | 409 | 0.97 | 2.3 |
| | POLYTEX A 1010 | 0.5 | 5 | 375 | 1.22 | 6.1 |
| | DCR (88 wt. %) + | 0.63 | 6.3 | 376 | 1.2 | 6 |
| | TAM-8 (12 wt. %) | 0.31 | 3.1 | 384 | 1.16 | 5 |
| | | 0.16 | 1.6 | 398 | 1.1 | 3.4 |
| | | 0.08 | 0.8 | 391 | 1.11 | 3.7 |
| | DCR (90 wt. %) + | 0.63 | 6.3 | 412 | 1.06 | 2.7 |
| | NP-6 (5 wt. %) + | 0.31 | 3.1 | 412 | 1.06 | 2.7 |
| | TOFA (5 wt. %) | 0.16 | 1.6 | 415 | 1.06 | 2.6 |
| | | 0.08 | 0.8 | 409 | 1.09 | 2.9 |

TABLE 5
Properties of DCR adjuvants

| | DCR + TAM-8 | DCR + NP-6 + TOFA |
|---|---|---|
| Properties | @ 0.31% v/v | @ 1% v/v |
| pH with 342 ppm water | 7.3 | 5.7 |
| Draves Wetting (s) | >300 | 97 |
| Surface Tension (Dynes/cm) | 35.3 | 32.8 |
| Viscosity (cP) | 264 | 272 |

As used herein, the term “comprising” means including elements or steps that are identified following that term, but any such elements or steps are not exhaustive, and an embodiment can include other elements or steps. Although the terms “comprising” and “including” have been used herein to describe various aspects, the terms “consisting essentially of” and “consisting of” can be used in place of “comprising” and “including” to provide for more specific aspects of the disclosure and are also disclosed.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items.

Unless otherwise specified, all technical and scientific terms used herein have the same meanings as commonly understood by one of skill in the art to which the disclosed disclosure belongs. the recitation of a genus of elements, materials or other components, from which an individual component or mixture of components can be selected, is intended to include all possible sub-generic combinations of the listed components and mixtures thereof.

The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. To an extent not inconsistent herewith, all citations referred to herein are hereby incorporated by reference.

1. An agricultural spray composition comprising:
0.02 to 5.0% v/v of a drift control adjuvant comprising:
50-95 wt. % of a decarboxylated rosin acid as a drift control agent;
5-50 wt. % of a surfactant system comprising one or more surfactants selected from nonionic, anionic, cationic, amphoteric surfactants, and mixtures thereof;
up to 20 wt. % optional components; and
wherein the decarboxylated rosin acid comprises one or more C═C groups, and 40-100 wt. % of tricyclic compounds having 18-20 carbon atoms;
95-99.98% v/v of an agricultural chemical component selected from the group of herbicides, insecticides, fungicides, rodenticides, bactericides, nematicides, algaecides, growth regulators, micronutrients, fertilizers and mixtures thereof; and
when the agricultural spray composition is discharged through one or more spray nozzles, the agricultural spray composition forms a plurality of spray droplets having at least one of:
a volume mean diameter (VMD) of 215-430 μm;
a fines fraction of 2-25% by volume for droplets having a diameter less than 141 μm; and
a relative span of 0.9-1.5.

2. The agricultural spray composition of claim 1, wherein sum of tricyclic compounds as aromatic and cycloaliphatic in the decarboxylated rosin acid is >50 wt. %, based on total weight of the decarboxylated rosin acid.

3. The agricultural spray composition of claim 2, wherein amount of the tricyclic cycloaliphatic compounds in the decarboxylated rosin acid is >15 wt. %, based on total weight of the decarboxylated rosin acid.

4. The agricultural spray composition of claim 1, wherein the decarboxylated rosin acid is characterized by one or more of:
an aniline point of 3-40° C., according to ASTM D611;
a pour point of −40 to +10° C., according to ASTM D97;
a flash point of 135-175° C., according to ASTM D92;
a boiling point of 200-390° C., according to ASTM D2887;
a Gardner Color of 0-12.0, according to ASTM D6166;
a sulfur content of <500 ppm, according to ASTM D5453;
a Kb (Kauri butanol) value of 25-90, according to ASTM D1133;
a viscosity index of −200 to −50, according to ASTM D2270;
a viscosity of 20-50 cSt, according to ASTM D-445 at 40° C.;
a δD value of 14-18;
a δP value of 3-6; and
a δH value of 7-10.

5. The agricultural spray composition of claim 1, wherein the agricultural chemical component comprises an agricultural chemical formulation containing at least one agricultural chemical active ingredient and a carrier.

6. The agricultural spray composition of claim 1, wherein the agricultural chemical component comprises an agricultural chemical active ingredient in a carrier, the agricultural chemical active ingredient being present at 0.1 to 2.0% v/v of the agricultural spray composition.

7. The agricultural spray composition of claim 1, wherein the agricultural spray composition is prepared by combining the drift control adjuvant with a concentrated agricultural chemical component to provide a concentrate composition, and diluting the concentrate composition with a carrier to provide the agricultural spray composition.

8. The agricultural spray composition of claim 1, wherein the agricultural spray composition is prepared by diluting a concentrated agricultural chemical component with a carrier to provide a diluted agricultural chemical composition, and adding the drift control adjuvant to provide the agricultural spray composition.

9. The agricultural spray composition of claim 1, wherein the surfactant system further comprises a fatty acid co-surfactant, optionally a tall oil fatty acid, in a surfactant-to-fatty acid ratio of 1:10 to 10:1.

10. The agricultural spray composition of claim 1, wherein the drift control adjuvant has at least one property selected from:
a Draves Wetting Time of less than 120 seconds, according to ASTM D2281;
a surface tension of 30-40 dynes/cm, according to ASTM D1331; and
a Brookfield viscosity of 140-280 cP, according to ASTM D2196.

11. The agricultural spray composition of claim 1, wherein the agricultural spray composition reduces the proportion of droplets less than 141 μm by at least 20% compared to water-only spray under identical nozzle and pressure conditions.

12. The agricultural spray composition of claim 1, wherein the agricultural chemical component is a herbicide selected from glyphosate, 2,4-D choline, dicamba, mesotrione, and mixtures thereof.

13. A method of preparing an agricultural spray composition, the method comprising:
combining a drift control adjuvant comprising 50-95 wt. % of a decarboxylated rosin acid, 5-50 wt. % of a surfactant system, and up to 20 wt. % of optional components with a concentrated agricultural chemical component to form a concentrate composition; and
diluting the concentrate composition with a carrier to provide the agricultural spray composition, the dilution being sufficient to provide 95.0 to 99.98% v/v of the agricultural chemical component in the agricultural spray composition;
wherein the decarboxylated rosin acid comprises one or more C═C groups, and 40-100 wt. % of tricyclic compounds having 18-20 carbon atoms;
wherein the agricultural chemical component is selected from herbicides, insecticides, fungicides, rodenticides, bactericides, nematicides, algaecides, growth regulators, micronutrients, fertilizers, and mixtures thereof.

14. The method of claim 13, wherein sum of tricyclic compounds as aromatic and cycloaliphatic in the decarboxylated rosin acid is >50 wt. %, based on total weight of the decarboxylated rosin acid.

15. The method of claim 14, wherein amount of the tricyclic cycloaliphatic compounds in the decarboxylated rosin acid is >15 wt. %, based on total weight of the decarboxylated rosin acid.

16. The method of claim 13, wherein the agricultural chemical component comprises an agricultural chemical active ingredient, and wherein the agricultural chemical active ingredient is present at 0.1 to 2.0% v/v of the agricultural spray composition.

17. The method of claim 13, wherein the agricultural chemical component comprises an agricultural chemical formulation containing at least one agricultural chemical active ingredient and a carrier.

18. A method of preparing an agricultural spray composition, the method comprising:
diluting a concentrated agricultural chemical component with a carrier to provide a diluted agricultural chemical composition; and
adding a drift control adjuvant to the diluted agricultural chemical composition to form an agricultural spray composition comprising 95.0 to 99.98% v/v of the agricultural chemical component;
wherein the drift control adjuvant comprises 50-95 wt. % of a decarboxylated rosin acid, 5-50 wt. % of a surfactant system, and up to 20 wt. % of optional components; and
wherein the decarboxylated rosin acid comprises one or more C═C groups, and 40-100 wt. % of tricyclic compounds having 18-20 carbon atoms.

19. The method of claim 18, wherein sum of tricyclic compounds as aromatic and cycloaliphatic in the decarboxylated rosin acid is >50 wt. %, based on total weight of the decarboxylated rosin acid.

20. The method of claim 18. wherein the agricultural chemical component comprises an agricultural chemical active ingredient and a carrier, and wherein the agricultural chemical active ingredient is present at 0.1 to 2.0% v/v of the agricultural spray composition.
